(19) United States
(12) Patent Application Publication
(10) Pub. No.: US 2019/0133369 A1
(43) Pub. Date: May 9, 2019

(54) KNOCK BOX-INTEGRATED CLEANER FOR COFFEE MACHINE PORTAFILTER

(71) Applicant: MANDRITECH CO., LTD., Ansan-si, Gyeonggi-do (KR)

(72) Inventor: Jun Hee YOO, Hwaseong-si (KR)

(73) Assignee: MANDRITECH CO., LTD., Ansan-si, Gyeonggi-do (KR)

(21) Appl. No.: 16/308,406

(22) PCT Filed: Dec. 16, 2016
(86) PCT No.: PCT/KR2016/014784

§ 371 Date: Dec. 7, 2018

(30) Foreign Application Priority Data
Jun. 9, 2016 (KR) 10-2016-0071880

(51) Int. Cl. A47J 31/60; A47J 31/36; A47J 31/06; B08B 1/04

(52) U.S. Cl. CPC A47J 31/60; A47J 31/36; A46B 13/02; B08B 1/04; A47J 31/06

(57) ABSTRACT

The present invention provides a knock box-integrated cleaner for a coffee machine portafilter, the knock box-integrated cleaner comprising: a knock box having an inner space part for receiving coffee grounds; a knock member in which fixing members are respectively coupled through guide rails to both sides of a cylindrical rubber bar disposed in the knock box, the guide rails being formed in upper parts of the knock box; a cleaner body in which a coupling projection and a mounting projection protrude from the cleaner body and a motor is installed in a center of a space part formed inside the body, the mounting projection having an upper part for mounting a handle of a portafilter; a collecting bucket which is inserted into the space part formed inside the cleaner body and has a protuberant part, formed protruding therefrom, for receiving the motor, and a space part for receiving coffee grounds inside, the protuberant part having a through hole formed in the upper end thereof, a motor shaft protruding out of the through hole; a brush having a lower part axially coupled to the motor shaft and an upper part protruding in a shape identical to the inner surface of a basket of the portafilter; a cover which is coupled to a top of the cleaner body and has an inner insertion hole into which the basket of the portafilter can be inserted; an ultraviolet lamp, installed inside the cleaner body, for irradiating an ultraviolet light to the brush; and a control panel, installed in a side surface of the cleaner body, for controlling the operation of the cleaner.

### TECHNICAL FIELD

The present invention relates to a knock box-integrated cleaner for a coffee machine portafilter and more specifically, to a device capable of separating and cleaning coffee grounds from a portafilter which is mounted onto a coffee machine and contains ground coffee.

### DESCRIPTION OF THE RELATED ART

In general, a coffee machine is used to extract coffee at high pressure within a short period of time. There are various extraction methods such as a capsule extraction method, a semi-automated extraction method and an automated extraction method. Through those extraction methods, espresso, latte, macchiato and mocha coffee etc. are made. A coffee machine is an important device for making espresso. Espresso is made through a series of complex cumbersome processes including production, purification, roasting and blending etc. Coffee machines are considered more scientific, rational and economical than any ever developed by humans to extract coffee.

A portafilter mounted onto the grouphead of a coffee machine is a filter for containing coffee and has a handle. Preferably, a portafilter is mounted onto the grouphead of a coffee machine with the right hand and force is applied with the left hand. This is a good way of causing no harmful effect on the wrist while the body is kept in a stable position. Be careful not to give a shock to a group when a portafilter is mounted onto a grouphead. When a shock is given to a group, tamped coffee may have cracks or the edges of coffee and a filter may be opened. If so, water flows first into a cracked part or an opened part. Thus, coffee has a weak taste. Preferably, the right hand is used to throw away coffee grounds after coffee is extracted. In this case, much coffee can be extracted without causing no harmful effect on the wrists or the shoulders. The remaining coffee grounds are preferably thrown away right before another coffee is extracted. If coffee grounds are thrown away right after coffee is extracted, the coffee grounds are attached to the grouphead while flowing in opposite directions because of pressure remaining in the machine. If coffee was extracted five or more minutes ago and then another coffee is extracted, coffee grounds in a portafilter are thrown away and the portafilter is washed and mounted onto the group. When coffee grounds are contained in a portafilter for a long period of time, moisture of the coffee grounds is dried and hardened with the coffee grounds in the portafilter.

Thus, a portafilter is conventionally detached from the grouphead of a coffee machine after coffee is extracted, coffee grounds remaining in the basket of the portafilter is separated while a shock is given to a knock box, and then the coffee grounds remaining in the basket is removed with a brush etc. Additionally, as a related art, South Korean Patent No. 10-1558136 (published on Oct. 6, 2015) discloses a filter basket cleaning apparatus for an espresso coffee machine.

However, in the process of removing coffee grounds remaining in a portafilter, the problem that coffee grounds remain in the basket of a portafilter is not solved. Thus, another coffee cannot have a desired taste after coffee is extracted, or pressure in a grouphead increases, due to the problem. Further, the problem can adversely affect the operation and hygiene of a coffee machined.

### DETAILED DESCRIPTION OF THE INVENTION

### Technical Problems

As a means to solve the above-described problems, the present invention is directed to providing a knock box-integrated cleaner for a coffee machine portafilter which is capable of primarily detaching coffee grounds contained in a basket of the coffee machine portafilter from a knock box and secondarily cleaning the coffee grounds remaining in the basket with a brush rotated by a motor, thereby allowing the portafilter to operate normally and ensuring hygiene.

Additionally, the present invention is directed to providing a knock box-integrated cleaner for a coffee machine portafilter where a knock box and a cleaner can be integrally coupled to each other or separately detached from each other.

Additionally, the present invention is also directed to providing a knock box-integrated cleaner for a coffee machine portafilter where the position of a rubber bar mounted onto a knock box can be controlled, the capacity of a knock box can be expanded, and a kitchen towel can be hung.

Additionally, the present invention is also directed to providing a knock box-integrated cleaner for a coffee machine portafilter where a brush can rotate when the basket of a portafilter is put on a brush of the cleaner and presses the brush, the rotation speed and operation pattern of the brush can be set, and ultraviolet rays can be radiated onto the brush so as to prevent bacteria from breeding.

### Technical Solutions

As a means to solve the purposes, the present invention is directed to providing a knock box-integrated cleaner for a coffee machine portafilter which includes: a knock box 10 provided with a handle on one side thereof and a coupling groove on the other side thereof and having an opened upper part and an inner space part for receiving coffee grounds; a knock member in which both sides of a cylindrical rubber bar on the inner side of the upper part of the knock box are respectively coupled to fixing members through guide rails formed on the upper part of the knock box; a body of the cleaner including a coupling projection which protrudes from one side of the body and is inserted into and fixedly coupled to the coupling groove the knock box, a mounting projection which protrudes from the upper part of the body such that the handle of the portafilter is put on the mounting projection, and a motor which is installed at the center of a space part formed inside the body; a collecting bucket which is inserted into the space part inside the body, has a protuberant part protruding from the center therein and accommodating the motor, wherein the protuberant part has a through hole at the upper end thereof so as to allow a motor shaft to protrude, and has an inner space part where coffee grounds are contained; a brush the lower part of which is axially coupled to the motor shaft protruding through the through hole of the protuberant part and which protrudes from the upper part thereof in a shape the same as that of the inner surface of the basket of the portafilter; a cover coupled to the top of the body and including an insertion hole which is formed inside the cover and into which the basket of the portafilter is inserted; an ultraviolet lamp installed inside the body and radiating ultraviolet rays onto the brush; and a control panel installed on the lateral surface of the body and manipulating the operation of the cleaner.

Additionally, according to the present invention, a clip is installed on one side of the knock box so as to fix a kitchen towel, and a closing plate may be provided on the inner bottom of the knock box so as to open and close the knock box.

Additionally, according to the present invention, the brush may be used for a single portafilter and a double portafilter.

Additionally, according to the present invention, the cover may consist of a transparent material or a translucent material.

Additionally, according to the present invention, the control panel may include an ultraviolet lamp switch for manipulating the operation of the ultraviolet lamp, a drive pattern selection switch for selecting the drive pattern of the motor, a plurality of display lamps for visibly displaying a selected drive pattern of the motor, a rotation speed control switch for controlling the rotation speed of the motor, a power switch 55 for operating the cleaner, and a power display lamp.

Additionally, according to the present invention, the motor includes a contact switch which is installed under the motor so as to control power supplied to the motor and is turned on and turned off according to the pressing force of the portafilter put on the brush and pressing the same.

Additionally, according to the present invention, when the ultraviolet lamp is lit, the motor may rotate at constant speed.

### Advantageous Effects

According to the present invention, a portafilter does ned after espresso coffee is extracted. Thus, the wear of a consumable gasket of a coffee machine is minimized, and expenses incurred to buy such a consumable gasket, which are usually imported, are reduced. The wear of a grouphead of a coffee machine is minimized because a basket of a portafilter is cleaned, cleaning time is reduced because coffee grounds are cleaned within two to five seconds with the cleaner when espresso coffee is continuously extracted, efficiency in a barista's work is improved because hygiene around a coffee machine is ensured, high-quality coffee with sweet, bitter, sour and salty tastes etc. and flavors typical of coffee can be produced because a minimum amount of coffee ground oil is generated in a grouphead and a shower filter where coffee is extracted, a drain is prevented from being blocked by coffee grounds because coffee grounds in a coffee basket do not come into a drain through a coffee machine, any harmful effect such as a shock applied on the wrists of baristas can be reduced because a knock member of a knock box can be moved and fixed with a fixing member for convenience in baristas' work, when a knock box is filled with coffee grounds, the knock box is easily detached from a body of the cleaner so as to remove the coffee grounds because a knock box has a handle, baristas do not have to have a kitchen towel hanging from the waist, and the kitchen towel can be used hygienically because a clip for fixing a kitchen towel to a knock box is provided, a brush can be sterilized with an ultraviolet lamp, and coffee grounds can fall into a large-scale collecting bucket through a through hole which is formed by a closing plate detached from a knock box because of a knock box with an expanded capacity, thereby making it possible to improve efficiency and reduce the time spent on work.

### BRIEF DESCRIPTION OF THE DRAWINGS

FIG. 1 is a perspective view of a knock box-integrated cleaner for a coffee machine portafilter according to an embodiment of the present invention.

FIG. 2 is an exploded perspective view of a knock box-integrated cleaner for a coffee machine portafilter according to the present invention.

FIG. 3 is a perspective view of a brush according to a single portafilter and a double portafilter in a knock box-integrated cleaner for a coffee machine portafilter according to the present invention.

FIG. 4 is a sectional view illustrating a state where a brush in a knock box-integrated cleaner for a coffee machine portafilter according to the present invention is sterilized with an ultraviolet sterilization lamp.

FIG. 5 is a sectional view illustrating a state where a knock box-integrated cleaner for a coffee machine portafilter according to the present invention operates.

### MODE FOR CARRYING OUT THE INVENTION

Embodiments of a knock box-integrated cleaner for a coffee machine portafilter according to the present invention will be specifically described with reference to the attached drawings.

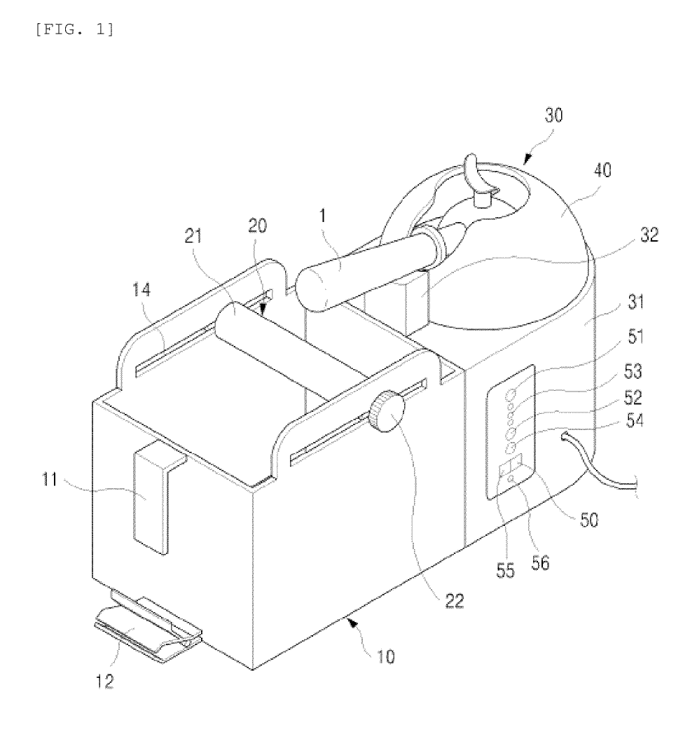

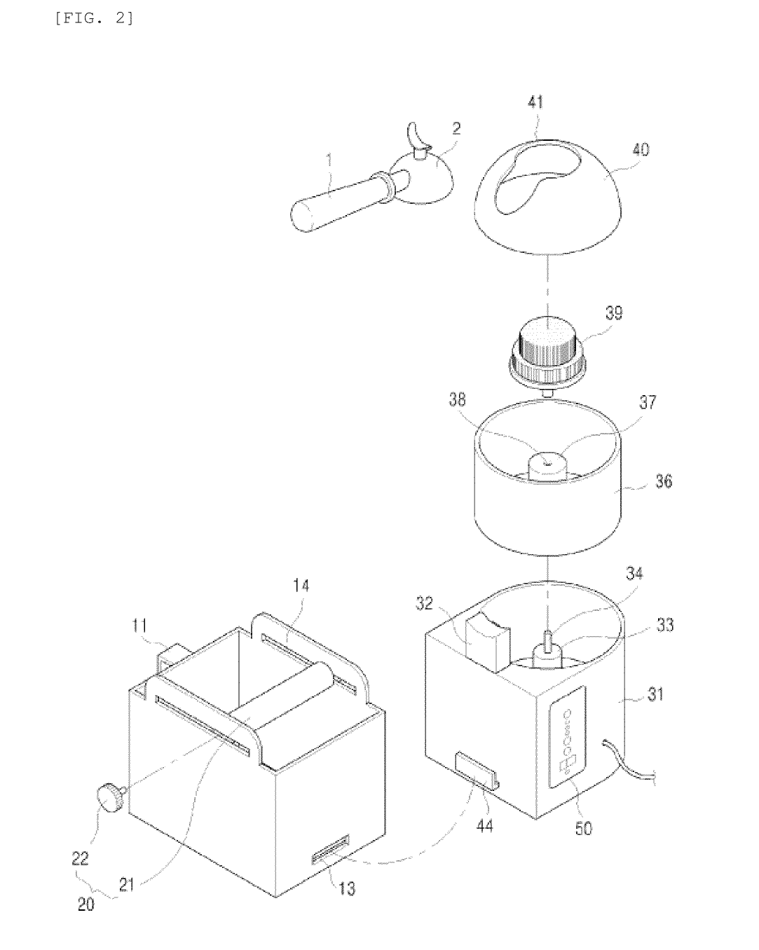

A knock box 10 illustrated in FIGS. 1 and 2 is separated from or integrated with a cleaner 30. The knock box 10 is configured as a container having an inner space part and an opened upper part so as to receive coffee grounds separated from a basket 2 of a portafilter 1. The knock box 10 is provided with a handle 11, which moves the knock box 10 and protrudes from the upper part of one side of the knock box 10, and a coupling groove 13 at the lower part of the other side of the knock box 10. Additionally, the knock box 10 includes a clip 12 on one side thereof, i.e. below the handle 11. The clip 12 is to fix a dried kitchen towel etc. used to dry the knock box 10 or the cleaner 30. Additionally, the knock box 10 is provided with a closing plate 15 for opening and closing the knock box 10 on the bottom therein. The closing plate 15 is fixed with a fixing member 16 such as a bolt etc. That is, when the closing plate 15 is fixed to the knock box 10, coffee grounds may be accommodated in the knock box 10. However, when the closing plate 15 is detached from the knock box 10, coffee grounds introduced into the knock box 10 passes through the lower portion of the knock box 10 so as to be introduced into the knock box. In this case, the knock box 10 preferably includes a large-scale collecting box for accommodating coffee grounds therebelow.

Meanwhile, the knock box 10 includes guide rails 14 for moving and fixing a knock member 20 on the inner side of the upper part thereof. Additionally, the knock member 20 is configured as a cylindrical rubber bar 21, and both sides of the knock members are respectively coupled to fixing members 22 through the guide rails 14 formed on the upper part of the knock box 10. Thus, the knock member 20 is fixed to the guide rails 14 of the knock box 10 by means of the fixing members 22 such as a bolt etc. coupled to both sides thereof. This enables a user to move and fix the knock member 20 when necessary. The cylindrical rubber bar 21 has elasticity such that the basket 2 of the portafilter 1 is not lost when hitting the surface of the cylindrical rubber bar. Additionally, the knock box 10 includes a plurality of silicone pads 17 coupled to the bottom surface thereof so as to prevent the vibration or slip thereof.

Next, a body 31 of the cleaner 30 integrally coupled to the knock box 10 has an approximate semi-cylinder shape and has an opened upper part and an inner space part. The body 31 includes a coupling projection 44 protruding from one side thereof such that the coupling projection is inserted into and fixedly coupled to the coupling groove 13 of the knock box 10. The body 31 includes a mounting projection 32 protruding from the upper part thereof such that the handle 11 of the portafilter 1 is put on the mounting projection 32. Additionally, the body 31 includes a motor 33 vertically installed at the center of the inner side thereof. The motor 33 includes a contact switch 35 that is installed under the motor and controls power supplied to the motor 33. The contact switch 35 is on and off depending on the pressing force of the portafilter 1, put on a brush 39 and pressing the same, and determines the operation of the motor 33. That is, when the contact switch 35 is off because pressing force is not applied to the motor 33, power is not supplied to the motor 33, and the motor 33 does not operate, and when the contact switch 35 is on because pressing force is applied to the motor 33, power is supplied to the motor 33, and the motor 33 operates. Further, the body 31 includes a plurality of silicone pads 43 coupled to the bottom surface thereof so as to prevent the vibration and slip thereof.

The body 31 includes a collecting bucket 36 that is inserted into the inner space part of the body and has a space part where coffee grounds are contained. The collecting bucket 36 includes a protuberant part 37 that protrudes from the center inside the collecting bucket 36 and accommodates the motor 33. The protuberant part 37 has a through hole 38 at the upper end thereof so as to allow a motor shaft 34 to protrude.

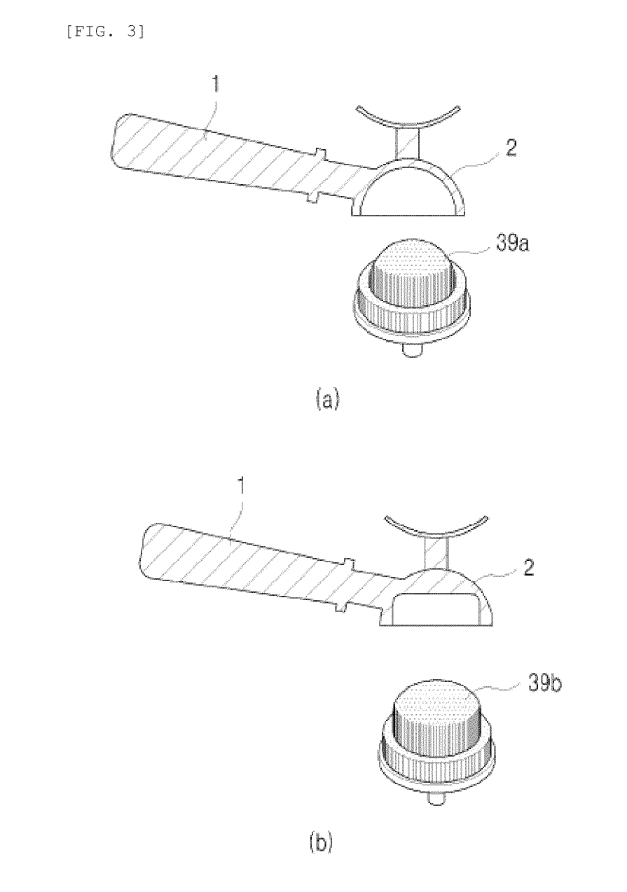

The brush 39 is used to clean the surface inside the basket 2 of the portafilter 1. The brush 39 has a lower part which is axially coupled to the motor shaft 34 protruding through the through hole 38 formed at the protuberant part 37 of the collecting bucket 36 and an upper part from which or animal fur or synthetic fur protrudes in a shape the same as that of the inner surface of the basket 2 of the portafilter 1. That is, when the portafilter 1 used for extracting coffee is a single one, the upper end of the brush 39a, as illustrated in FIG. 3a, preferably has an arc shape, and when the portafilter 1 used for extracting coffee is a double one, the upper end of the brush 39b, as illustrated in FIG. 39b, preferably has a flat shape.

A cover 40 is coupled to the top of the body 31 and includes an insertion hole 41 which is formed inside the cover and into which the basket 2 of the portafilter 1 may be inserted. Preferably, the cover 40 is configured to be transparent or translucent.

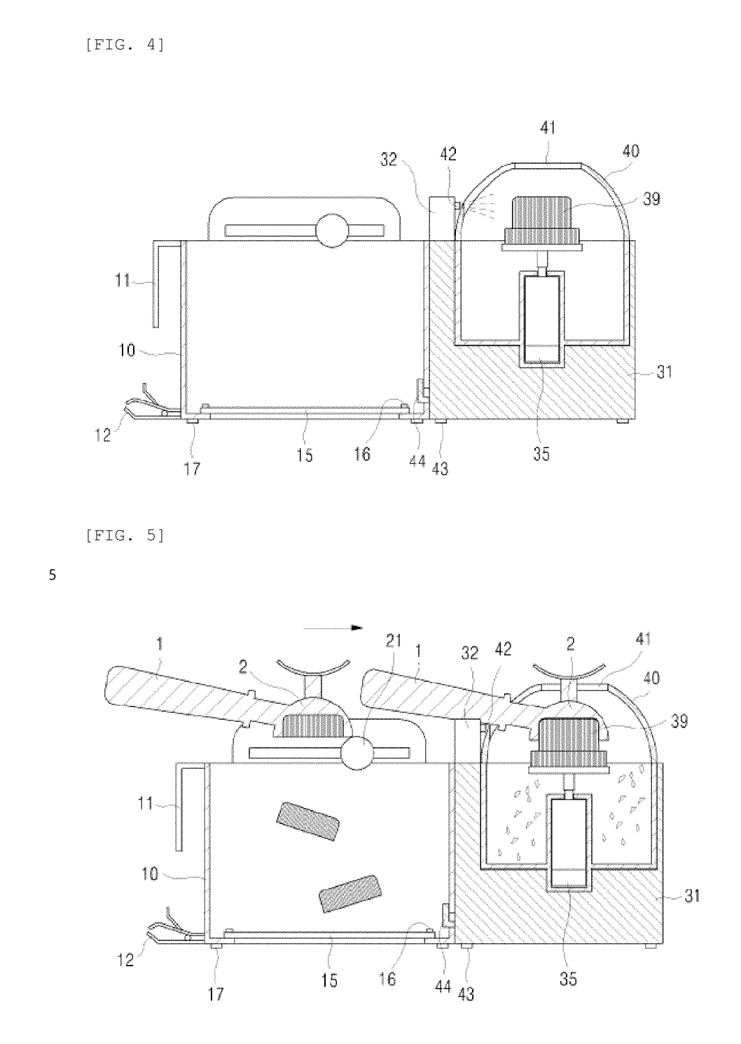

Additionally, the body 31 includes an ultraviolet lamp 42 installed on the wall of the inner side thereof. The ultraviolet lamp 42, as illustrated in FIG. 4, radiates ultraviolet rays onto the brush 39 and sterilizes the same. Preferably, the ultraviolet lamp 42 operates for a certain period of time even when the cleaner 30 is not being used. Additionally, when the ultraviolet lamp 42 operates and radiates ultraviolet rays, the motor 33 preferably continues to rotate at low speed. Further, the ultraviolet lamp 42 is preferably turned off after a predetermined period of the operation thereof.

A control panel 50 is installed on the lateral surface of the body 31 and manipulates the operation of the cleaner 30. The control panel 50 is provided with an ultraviolet lamp switch 51 for manipulating the operation of the ultraviolet lamp, a drive pattern selection switch 52 for selecting the drive pattern of the motor 33, and a plurality of display lamps 53 for visibly displaying a selected drive pattern of the motor 33. Additionally, the control panel 50 includes a rotation speed control switch 54 for controlling the rotation speed of the motor 33, a power switch 55 for operating the cleaner 30, and a power display lamp 56. Further, the control panel 50 includes a controller such as a microcomputer etc. mounted onto a substrate built into the cleaner so as to control the operation of the motor and lamps according to the input of the above-described switches.

The operation of a knock box-integrated cleaner for a coffee machine portafilter according to the present invention with the above-described configuration is described as follows with reference to FIG. 5.

First, a power switch 55 of the body 31 of the knock box 10-integrated cleaner is turned on so as to determine whether a power display lamp 56 is turned on. Next, a portafilter 1 is detached from a grouphead after coffee is extracted with a coffee machine so as to remove coffee grounds in the portafilter 1. A basket 2 of the portafilter 1 detached from the grouphead is hit with a certain level of intensity against a rubber bar 21 of a knock member 20 fixed to the upper part of the knock box 10 so as to detach coffee grounds contained in the basket 2 and to drop the same into the knock box 10. The knock member 20 moves along a guide rail 14 configured as a long hole and then is fixed by means of fixing members 22 so as to be freely positioned at any portion of the guide rail for user convenience.

Further, the basket 2 of the portafilter 1 is inserted into an insertion hole 41 formed on a cover 40 of the body 31, is put on a brush 39 and then presses the brush with a certain level of intensity such that the remaining coffee grounds, not detached from the basket 2 of the portafilter 1, are removed. In this case, a contact switch 35 installed under a motor 33 is turned on, power is supplied to the motor 33, and the brush 39 rotates for about two to five seconds while cleaning the inner surface of the basket 2 so as to completely detach the coffee grounds. Additionally, a brush 39 having a shape the same as that of the inner surface of the basket 2 is used depending on a portafilter 1 configured as a single one (single shot) or a double one (double shot). Additionally, the coffee grounds that are cleaned and detached while the brush 39 rotates are dropped into a collecting bucket 36. When coffee grounds reach a certain height of the collecting bucket 36, the cover 40 of the body 31 is opened, the brush 39 is detached from a motor shaft 34, and then the collecting bucket 36 is detached from the body 31 so as to empty the collecting bucket 36 of the coffee grounds. Further, the collecting bucket 36, the brush 39 and the cover 40 may be installed in the body 31 in reverse order.

Meanwhile, the rotation sped of the brush 39 may be controlled through the manipulation of a rotation speed control switch 54 or may be selected through the manipulation of a drive pattern selection switch 52 such that the coffee grounds remaining on the inner surface of the basket 2 of the portafilter 1 may be removed and cleaned. Additionally, the rotation speed and the rotation pattern of the brush 39 may be set according to the way that a user such as a barista etc. works. When the rotation pattern of the brush 39 is not selected, the brush 39 rotates forwards by means of the drive of the motor 33. Additionally, while the basket 2 of the portafilter 1 presses the brush 39 such that the brush contacts the contact switch 35, the rotation pattern of the brush 39 may be selected among pattern A, pattern B, and pattern C. That is, according to pattern A, the brush rotates forwards for 0.8 second, stops for 0.5 second, rotates forwards for 0.8 second and stops for 0.5 second repeatedly. According to pattern B, the brush rotates forwards for 1.5 seconds, stops for 0.5 second, rotates forwards for 1.5 seconds and stops for 0.5 second repeatedly. According to pattern C, the brush rotates forwards for 1 second, stops for 0.5 second, rotates reversely for 1 second, stops for 0.5 second, rotates forwards for 1 second, stops for 0.5 second, rotates reversely for 1 second and stops for 0.5 second repeatedly. The operation of each pattern may be recognized through the lighting of the display lamp 53 provided to a control panel 50.

Additionally, a kitchen towel may be fastened to a clip 12 provided to the knock box 10 so as to be used when necessary, thereby ensuring cleanliness in managing a coffee machined and removing coffee grounds. When the knock box 10 is filled with coffee grounds, a handle 11 provided to the knock box 10 may be used to detach the knock box 10 from the body 31, and then the knock box 10 may be emptied.

Further, while the cleaner 30 is not being used when an ultraviolet lamp switch 51 of the control panel 50 operates, an ultraviolet lamp 42, installed on the inner surface of the body 31, operates and at the same time, the brush 39 rotates at low speed. The ultraviolet lamp 42 radiates ultraviolet rays for about two to five minutes so as to sterilize the brush 39 rotating at low speed and then is turned off. Accordingly, the brush 39 stops rotating.

The present invention has been illustrated and described in relation to the embodiments. However, it will be apparent to one having ordinary skill in the art to which the present invention pertains that the present invention may be modified and changed in many different forms without departing from the spirit and scope of the present invention in the appended claims.

### INDUSTRIAL APPLICABILITY

A knock box-integrated cleaner for a coffee machine portafilter of the present invention is capable of primarily detaching coffee grounds contained in a basket of the coffee machine portafilter from a knock box and secondarily cleaning the coffee grounds remaining in the basket with a brush rotated by a motor, thereby allowing the portafilter to operate normally and ensuring hygiene. Thus, the present invention is industrially applicable.

1. A knock box-integrated cleaner for a coffee machine portafilter comprising:
a knock box provided with a handle on one side thereof and a coupling groove on the other side thereof and having an opened upper part and an inner space part for receiving coffee grounds;
a knock member in which both sides of a cylindrical rubber bar on the inner side of the upper part of the knock box are respectively coupled to fixing members through guide rails formed on the upper part of the knock box;
a body of the cleaner including a coupling projection which protrudes from one side of the body and is inserted into and fixedly coupled to the coupling groove the knock box, a mounting projection which protrudes from the upper part of the body such that the handle of the portafilter is put on the mounting projection, and a motor which is installed at the center of a space part formed inside the body;
a collecting bucket which is inserted into the space part inside the body, has a protuberant part protruding from the center therein and accommodating the motor wherein the protuberant part has a through hole at the upper end thereof so as to allow a motor shaft to protrude, and has an inner space part where coffee grounds are contained;
a brush the lower part of which is axially coupled to the motor shaft protruding through the through hole of the protuberant part and which protrudes from the upper part thereof in a shape the same as that of the inner surface of the basket of the portafilter;
a cover coupled to the top of the body and including an insertion hole which is formed inside the cover and into which the basket of the portafilter is inserted;
an ultraviolet lamp installed inside the body and radiating ultraviolet rays onto the brush; and
a control panel installed on the lateral surface of the body and manipulating the operation of the cleaner.

2. The knock box-integrated cleaner for a coffee machine portafilter according to claim 1, wherein the knock box comprises a clip which is installed on one side of the knock box so as to fix a kitchen towel, and a closing plate which is provided on the inner bottom of the knock box so as to open and close the knock box.

3. The knock box-integrated cleaner for a coffee machine portafilter according to claim 1, wherein the brush is used for a single portafilter and a double portafilter.

4. The knock box-integrated cleaner for a coffee machine portafilter according to claim 1, wherein the cover consists of a transparent material or a translucent material.

5. The knock box-integrated cleaner for a coffee machine portafilter according to claim 1, wherein the control panel comprises an ultraviolet lamp switch for manipulating the operation of the ultraviolet lamp, a drive pattern selection switch for selecting the drive pattern of the motor, a plurality of display lamps for visibly displaying a selected drive pattern of the motor, a rotation speed control switch for controlling the rotation speed of the motor, a power switch for operating the cleaner, and a power display lamp.

6. The knock box-integrated cleaner for a coffee machine portafilter according to claim 1, wherein the motor comprises a contact switch which is installed under the motor so as to control power supplied to the motor and is turned on and turned off according to the pressing force of the portafilter put on the brush and pressing the same.

7. The knock box-integrated cleaner for a coffee machine portafilter according to claim 1, wherein when the ultraviolet lamp is lit, the motor rotates at constant speed.
